(19) United States
(12) Patent Application Publication
(10) Pub. No.: US 2026/0193529 A1
(43) Pub. Date: Jul. 9, 2026

(54) INORGANIC HYDROCARBON SCAVENGER FLUID

(71) Applicant: Halliburton Energy Services, Inc., Houston, TX (US)

(72) Inventors: Antonio RECIO, III, Houston, TX (US); Angelica Maria Rojas ZAMBRANO, Neiva (CO); Kristina Henkel HOLAN, Houston, TX (US); Enrique Antonio REYES, Houston, TX (US); Guillermo IZQUIERDO, Bogota (CO)

(73) Assignee: Halliburton Energy Services, Inc., Houston, TX (US)

(21) Appl. No.: 19/015,433

(22) Filed: Jan. 9, 2025

(51) Int. Cl. C09K 8/68; C09K 8/60; C09K 8/66; C09K 8/84; C09K 8/86

(52) U.S. Cl. CPC C09K 8/68; C09K 8/602; C09K 8/665; C09K 8/845; C09K 8/86; C09K 2208/10

(57) ABSTRACT

The present disclosure provides formulations for hydrocarbon scavenger fluids and methods for treating a subterranean formation with a hydrocarbon scavenger fluid. An example method introduces a hydrocarbon scavenger fluid into a wellbore penetrating the subterranean formation and contacts a rock surface in the subterranean formation with the hydrocarbon scavenger fluid. The hydrocarbon scavenger fluid includes a microemulsion and a water-based nanoparticle dispersion.

### TECHNICAL FIELD

The present disclosure relates generally to wellbore operations, and more particularly, to the use of a hydrocarbon scavenger fluid to improve hydrocarbon mobility in a wellbore.

### BACKGROUND

Fracturing, restimulating, waterflooding, and enhanced oil recovery operations may be used to reverse formation damage caused during primary production. One such technique is to remove an oil coating on a rock surface and then alter the wettability of the rock surface to be water-wet. Oil heavy ends such as asphaltenes and waxes can resist fluid flow and remain on surfaces they contact. These oil heavy ends may trap the oil therein by reducing permeability and flowthrough. Further, these oil heavies may resist displacement, impacting attempts to improve production and prevent further formation damage. Oil-wet surfaces may decrease production by decreasing communication between secondary fractures or porosity and main fractures or hydraulically created (fracturing) fractures; furthermore, communication from any of the preceding conductive systems to the wellbore and its adjacent area (near wellbore area) may also be affected by oil-wetting. Oil-wet proppant packs may have decreased permeability.

Moreover, some formations may be highly permeable yet have low fluid mobility. Driving hydrocarbon fluids out of these formations may prove difficult under some circumstances.

Regardless of the chosen operation, altering the wettability of a rock surface to be water-wet and improving hydrocarbon mobility may improve subsequent recovery and production operations. The present disclosure provides improved methods and compositions for improving the mobility and recovery of hydrocarbon fluids without the need for energized fluids such as compressed or liquified gases.

### BRIEF DESCRIPTION OF THE DRAWINGS

Illustrative examples of the present disclosure are described in detail below with reference to the attached drawing figures, which are incorporated by reference herein, and wherein:

FIG. 1 is a graph illustrating the Kauri-Butanol value for various species of non-water-miscible substances wellbore in accordance with one or more examples described herein;

FIG. 2 is a schematic illustrating a system of surface equipment for the preparation and delivery of a hydrocarbon scavenger fluid to a wellbore in accordance with one or more examples described herein;

FIG. 3 is a schematic illustrating the placement of a hydrocarbon scavenger fluid into a fracture in a subterranean formation in accordance with one or more examples described herein; and

FIG. 4 is a schematic illustrating the treatment of a production well with a hydrocarbon scavenger fluid in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to wellbore operations, and more particularly, to the use of a hydrocarbon scavenger fluid to improve hydrocarbon mobility in a wellbore.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms uphole and downhole may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The terms upstream and downstream may be used to refer to the location of various components relative to one another in regards to the flow of a sample through said components. For example, a first component described as upstream from a second component will encounter a sample before the downstream second component encounters the sample. Similarly, a first component described as being downstream from a second component will encounter the sample after the upstream second component encounters the sample.

As used herein the weight/volume (“w/v”) is to be understood to mean the grams/milliliters and the weight/volume percentage (“% w/v”) is to be understood to mean the grams/milliliters multiplied by 100.

The present disclosure relates generally to wellbore operations, and more particularly, to the use of a hydrocarbon scavenger fluid to improve hydrocarbon displacement in a reservoir and mobility in a wellbore. A formation can be sedimentary rock, metamorphic rock, volcanic rock, or maphic or ultramaphic rock. Advantageously, the hydrocarbon scavenger fluid provides wettability modification to surfaces in a subterranean formation. For example, the hydrocarbon scavenger fluid may remove hydrocarbons from the surface of the geologic formation or from the surfaces of particulates in the formation (e.g., proppant), or alternatively from engineered surfaces such as tubulars or tubing and equipment and alter these surfaces to be water-wet. In a specific example, the hydrocarbon scavenger fluid removes hydrocarbons from the surface of quartz and silicate minerals which can comprise the geologic formation itself or may be artificially introduced. As a further advantage, the hydrocarbon scavenger fluid comprises a microemulsion and a nanoparticle dispersion blend. The combination of the microemulsion and the nanoparticle dispersion produces a synergistic effect on the modification of contact angle measurements obtained at the rock/fluid interface. In some cases, a reduction in the measured contact angle of the surfactant and nanoparticle dispersion blend results in an overall improvement in wettability. Essentially the oil has a lower affinity to the rock surface, and the water has a higher affinity to the rock surface. The hydrocarbon scavenger fluid's wettability alteration of formation surfaces and improvement in the mobility of hydrocarbon fluids may increase the production of hydrocarbons from a subterranean formation. As a still further advantage, the hydrocarbon scavenger fluids disclosed herein may provide an improvement in the hydrocarbon mobility in subterranean formations that have high permeability and low fluid mobility. Additionally, the hydrocarbon scavenger fluid may be used in a variety of wellbore operations including the stimulation of hydrocarbon production, fracturing of a subterranean formation, flooding a subterranean formation or wellbore for a water flooding operation, and the like. As an additional advantage, the hydrocarbon scavenger fluid has a reduced droplet size, a desirable zeta potential, both suggestive of a stable fluid formulation, and reduces interfacial tension to a desired degree.

The hydrocarbon scavenger fluid may increase hydrocarbon mobility in the subterranean formation and may alter the wettability of the formation surfaces as well as the surfaces of particulates introduced into the formation such as proppant. The hydrocarbon scavenger fluid may alter the wettability of these surfaces to be water-wet, which may improve subsequent recovery and production operations. Wettability is the capacity of a fluid to spread and contact a solid surface. By introducing the hydrocarbon scavenger fluid to a rock formation, wettability of some of the formation surfaces may be altered. The methods and compositions disclosed herein improve the mobility and recovery of hydrocarbon fluids without the need for energized fluids such as compressed or liquified gases (e.g., liquefied natural gas (LNG) and cryogenic gases such as CO₂, CH₄, H₂, N₂.

The hydrocarbon scavenger fluid comprises a microemulsion and a water-based nanoparticle dispersion. The water-based nanoparticle dispersion may be non-functionalized as discussed below. The microemulsion is a thermodynamically stable, isotropic mixture of a non-water-miscible phase, an aqueous phase, at least one surfactant, and at least one co-solvent. A microemulsion, as used herein, has a droplet size of less than 300 nanometers (nm), for example, between about 1 nm to about 300 nm. The nanoparticle dispersion is a dispersion of nanoparticles into an aqueous base fluid. The nanoparticle dispersion may be combined with the microemulsion or its individual components in any order. The combination of the microemulsion and nanoparticle dispersion produces the hydrocarbon scavenger fluid, which may also be referred to as nanofluid, a single-phase solution that can be classified as transparent.

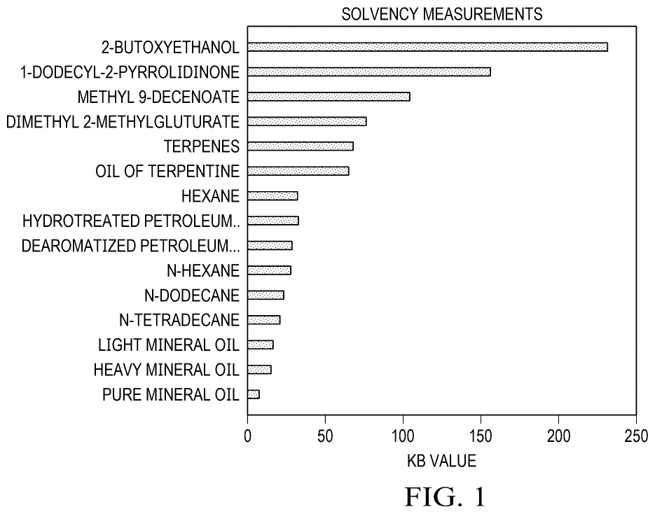

The microemulsion comprises a non-water-miscible phase composed of at least one non-water-miscible substance. The non-water-miscible substance is combined with the other microemulsion components or the nanoparticle dispersion in any order. The species of non-water-miscible substances may be differentiated based on their Kauri-butanol (KB) values. The KB value is a standardized measure of the solvent power of a hydrocarbon-based solvent. The KB value is determined via the American Society for Testing and Materials standardized testing procedure characterized in the Standard Test Method for Kauri-Butanol Value of Hydrocarbon Solvents, classified as ASTM D1133-10. Higher KB values are indicative of the capability of a given polar solvent to dissolve more hydrocarbon material. Examples of the non-water miscible substance may include, but are not limited to, 2-butoxyethanol, 1-dodecyl-2-pyrrolidinone, methyl-9-decenoate, dimethyl succinate, dimethyl glutarate, dimethyl adipate, dimethyl-2-methylgluturate, ditertbutyl gluturate, dimethyl carbonate, dibutyl sulfate, di-terbutyl sulfate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, or a combination of non-water-miscible substances. Generally, the hydrotreated petroleum distillates may contain formulations having an alkane concentration of about 4% to about 8%, an alkene concentration of about 2-5%, an isoalkane concentration of about 25% to about 40%, a cycloalkane concentration of about 3% to about 7%, a cycloalkene concentration of about 1% to about 4%, and an aromatic concentration of about 20% to about 50%. Generally, the dearomatized petroleum distillates may contain formulations having an alkane concentration of about 40% to about 70%, an isoalkane concentration of about 20% to about 50%, a cycloalkane concentration of about 5% to about 20%, and an aromatic concentration of about 1%. Such non-water miscible substances can also be a hydrocarbon-miscible phase. In a specific example, the KB value of the non-water miscible substance is between about 0 to about 250. A preferred range for the KB value is about 0 to about 40. FIG. 1 illustrates an example graph of measured KB values for various species of the non-water-miscible substances. Higher KB values produce high polarity microemulsions and lower KB values produce lower polarity microemulsions. For the purpose of this disclosure, the term “high-polarity microemulsion” refers to microemulsions with non-water miscible substances having KB values greater than 50 and the term “low-polarity microemulsion” refers to microemulsions with non-water miscible substances having KB values less than 50.

The concentration of the non-water-miscible substance in a hydrocarbon scavenger fluid may range from about 0.1% w/v to about 25% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the non-water-miscible substance in a hydrocarbon scavenger fluid may range from about 0.1% (w/v) to about 25% (w/v), from about 0.5% (w/v) to about 25% (w/v), from about 1% (w/v) to about 25% (w/v), from about 2% (w/v) to about 25% (w/v), from about 3% (w/v) to about 25% (w/v), from about 4% (w/v) to about 25% (w/v), from about 5% (w/v) to about 25% (w/v), from about 6% (w/v) to about 25% (w/v), from about 7% (w/v) to about 25% (w/v), from about 8% (w/v) to about 25% (w/v), from about 9% (w/v) to about 25% (w/v), from about 10% (w/v) to about 25% (w/v), from about 11% (w/v) to about 25% (w/v), from about 12% (w/v) to about 25% (w/v), from about 13% (w/v) to about 25% (w/v), from about 14% (w/v) to about 25% (w/v), from about 15% (w/v) to about 25% (w/v), from about 16% (w/v) to about 25% (w/v), from about 17% (w/v) to about 25% (w/v), from about 18% (w/v) to about 25% (w/v), from about 19% (w/v) to about 25% (w/v), from about 20% (w/v) to about 25% (w/v), from about 21% (w/v) to about 25% (w/v), from about 22% (w/v) to about 25% (w/v), from about 23% (w/v) to about 25% (w/v), or from about 24% (w/v) to about 25% (w/v). As another example, the concentration of the non-water-miscible substance in a hydrocarbon scavenger fluid may range from about 0.1% (w/v) to about 25% (w/v), from about 0.1% (w/v) to about 24% (w/v), from about 0.1% (w/v) to about 23% (w/v), from about 0.1% (w/v) to about 22% (w/v), from about 0.1% (w/v) to about 21% (w/v), from about 0.1% (w/v) to about 20% (w/v), from about 0.1% (w/v) to about 19% (w/v), from about 0.1% (w/v) to about 18% (w/v), from about 0.1% (w/v) to about 17% (w/v), from about 0.1% (w/v) to about 16% (w/v), from about 0.1% (w/v) to about 15% (w/v), from about 0.1% (w/v) to about 14% (w/v), from about 0.1% (w/v) to about 13% (w/v), from about 0.1% (w/v) to about 12% (w/v), from about 0.1% (w/v) to about 11% (w/v), from about 0.1% (w/v) to about 10% (w/v), from about 0.1% (w/v) to about 9% (w/v), from about 0.1% (w/v) to about 8% (w/v), from about 0.1% (w/v) to about 7% (w/v), from about 0.1% (w/v) to about 6% (w/v), from about 0.1% (w/v) to about 5% (w/v), from about 0.1% (w/v) to about 4% (w/v), from about 0.1% (w/v) to about 3% (w/v), from about 0.1% (w/v) to about 2% (w/v), from about 0.1% (w/v) to about 1% (w/v), or from about 0.1% (w/v) to about 0.5% (w/v). With the benefit of this disclosure, one of ordinary skill in the art will be readily able to prepare a hydrocarbon scavenger fluid having a desirable concentration of non-water-miscible for use in a given wellbore operation.

The hydrocarbon scavenger fluid described herein comprises an aqueous phase composed of water. Examples of the water may include, but are not limited to, freshwater, saltwater (e.g., water containing one or more salts dissolved therein), brine (e.g., saturated saltwater, including saturated saltwater produced from subterranean formations), seawater, or any combination thereof. Generally, the water may be from any source provided that the water does not contain an excess of compounds that may undesirably affect other components in the hydrocarbon scavenger fluid. In the case of brines, the brine may comprise a monovalent brine or a divalent brine. Suitable monovalent brines may include, for example, sodium chloride brines, sodium bromide brines, potassium chloride brines, potassium bromide brines, ammonium-containing brines such as ammonium chloride, ammonium bromide, ammonium nitrate, ammonium nitrite, ammonium acetate, ammonium formate, ammonium sulfate, ammonium carbonate, and ammonium hydroxide, and the like. Suitable divalent brines may include, for example, magnesium chloride brines, calcium chloride brines, calcium bromide brines, zinc bromide brines, and the like. For reasons of economics, supply and availability, the use of seawater as a source of water is also plausible taking into account the variability in seawater chemistry; likewise the use of produced water, which can have a high degree of chemical variability (ionic composition, pH, dissolved chemicals such as CO₂, H₂S) is further optional. One of ordinary skill in the art, with the benefit of this disclosure, should be readily able to select a water for the aqueous phase of the microemulsion for a chosen application.

The concentration of the water in the hydrocarbon scavenger fluid may range from about 1% (w/v) to about 99% (w/v). The concentration of the water in the hydrocarbon scavenger fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the water in the hydrocarbon scavenger fluid may range from about 1% (w/v) to about 99% (w/v), from about 5% (w/v) to about 99% (w/v), from about 10% (w/v) to about 99% (w/v), from about 15% (w/v) to about 99% (w/v), from about 20% (w/v) to about 99% (w/v), from about 25% (w/v) to about 99% (w/v), from about 30% (w/v) to about 99% (w/v), from about 35% (w/v) to about 99% (w/v), from about 40% (w/v) to about 99% (w/v), from about 45% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the water in the hydrocarbon scavenger fluid may range from about 1% (w/v) to about 99% (w/v), from about 1% (w/v) to about 95% (w/v), from about 1% (w/v) to about 90% (w/v), from about 1% (w/v) to about 85% (w/v), from about 1% (w/v) to about 80% (w/v), from about 1% (w/v) to about 75% (w/v), from about 1% (w/v) to about 70% (w/v), from about 1% (w/v) to about 65% (w/v), from about 1% (w/v) to about 60% (w/v), from about 1% (w/v) to about 55% (w/v), from about 1% (w/v) to about 50% (w/v), from about 1% (w/v) to about 45% (w/v), from about 1% (w/v) to about 40% (w/v), from about 1% (w/v) to about 35% (w/v), from about 1% (w/v) to about 30% (w/v), from about 1% (w/v) to about 25% (w/v), from about 1% (w/v) to about 20% (w/v), from about 1% (w/v) to about 15% (w/v), from about 1% (w/v) to about 10% (w/v), or from about 1% (w/v) to about 5% (w/v). With the benefit of this disclosure, one of ordinary skill in the art will be able to prepare a hydrocarbon scavenger fluid having a sufficient concentration of a water for a given application.

The microemulsion comprises a surfactant blend of at least two surfactants. The surfactants may be from a class characterized as, but are not limited to, ionic, non-ionic, cationic, zwitterionic, amphiphilic, or amphoteric. The surfactants may be combined with the other microemulsion components or the nanoparticle dispersion in any order. Examples of the surfactants may include, but are not limited to, alkanolamides, alkylamine alkoxylates, polyether polyamines, alkoxylated polyethylene amine, alkoxylated linear alcohols, alkoxylated branched alcohols, alkoxylated secondary alcohols, alkoxylated Guerbet alcohol, alkoxylated alkylphenol, alkoxylated fatty acids, castor oil ethoxylates, alkoxylated glycerol, alkyl glycosides, alkylamine-oxides, alkoxylated sorbitol alkoxylated alkylphenol resin, ethylene oxide and propylene oxide block copolymers, reverse EO/PO block copolymers, polyether polyols, triethanolamine linear alkoxylate sulfonate, bis-oxo-diphenol-di-sulfonate, alkoxylated phosphate complexes, aliphatic phosphate, phosphate esters, acetylenic alkoxylated gemini surfactant, polyether siloxane copolymer, glycolipids such as sophorolipid, Rhamnolipid, or a combination of surfactants.

The concentration of the total surfactant amount in a hydrocarbon scavenger fluid may range from about 0.025% w/v to about 20% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the total surfactant amount in a hydrocarbon scavenger fluid may range from about 0.025% (w/v) to about 20% (w/v), from about 0.05% (w/v) to about 20% (w/v), from about 0.075% (w/v) to about 20% (w/v), from about 0.1% (w/v) to about 20% (w/v), from about 0.5% (w/v) to about 20% (w/v), from about 1% (w/v) to about 20% (w/v), from about 2% (w/v) to about 20% (w/v), from about 3% (w/v) to about 20% (w/v), from about 4% (w/v) to about 20% (w/v), from about 5% (w/v) to about 20% (w/v), from about 6% (w/v) to about 20% (w/v), from about 7% (w/v) to about 20% (w/v), from about 8% (w/v) to about 20% (w/v), from about 9% (w/v) to about 20% (w/v), from about 10% (w/v) to about 20% (w/v), from about 11% (w/v) to about 20% (w/v), from about 12% (w/v) to about 20% (w/v), from about 13% (w/v) to about 20% (w/v), from about 14% (w/v) to about 20% (w/v), from about 15% (w/v) to about 20% (w/v), from about 16% (w/v) to about 20% (w/v), from about 17% (w/v) to about 20% (w/v), from about 18% (w/v) to about 20% (w/v), or from about 19% (w/v) to about 20% (w/v). As another example, the concentration of the total surfactant amount in a hydrocarbon scavenger fluid may range from about 0.025% (w/v) to about 20% (w/v), from about 0.025% (w/v) to about 19% (w/v), from about 0.025% (w/v) to about 18% (w/v), from about 0.025% (w/v) to about 17% (w/v), from about 0.025% (w/v) to about 16% (w/v), from about 0.025% (w/v) to about 15% (w/v), from about 0.025% (w/v) to about 14% (w/v), from about 0.025% (w/v) to about 13% (w/v), from about 0.025% (w/v) to about 12% (w/v), from about 0.025% (w/v) to about 11% (w/v), from about 0.025% (w/v) to about 10% (w/v), from about 0.025% (w/v) to about 9% (w/v), from about 0.025% (w/v) to about 8% (w/v), from about 0.025% (w/v) to about 7% (w/v), from about 0.025% (w/v) to about 6% (w/v), from about 0.025% (w/v) to about 5% (w/v), from about 0.025% (w/v) to about 4% (w/v), from about 0.025% (w/v) to about 3% (w/v), from about 0.025% (w/v) to about 2% (w/v), from about 0.025% (w/v) to about 1% (w/v), from about 0.025% (w/v) to about 0.5% (w/v), from about 0.025% (w/v) to about 0.1% (w/v), from about 0.025% (w/v) to about 0.075% (w/v), or from about 0.025% (w/v) to about 0.05% (w/v). With the benefit of this disclosure, one of ordinary skill in the art will be readily able to prepare a hydrocarbon scavenger fluid having a desirable concentration of surfactant for use in a given wellbore operation.

The microemulsion comprises at least one co-solvent which is a part of the surfactant blend. The co-solvent is combined with the other microemulsion components or the nanoparticle dispersion in any order. Examples of the co-solvent may include, but are not limited to, methanol, ethanol, n-propanol, isopropanol, 1-butanol, 2-butanol, isobutanol, tert-butanol, pentanol and any of its isomers, cyclohexanol, isotridecyl alcohol, glycerol, tetrahydrofurfuryl alcohol (THFA), furfuryl alcohol (FAO), the corresponding diols of any of the prior alcohol such as 1,2-propanediol, 1,3-or 1,4-butanediol, 1,5-pentanediol, 1,6-hexanediol, ethylene glycol monobutyl ether, polyethylene glycol, polyethylene glycol monobutyl ether, cyclopentanone, dihydrolevoglucosenone, dimethylisosorbide, and Methyl-5-(dimethylamino)-2-methyl-5-oxopentanoate, cyclohexanone, 2-methyltetrahydrofuran (2-MeTHF), gamma-Butyrolactone (GBL), gamma-Valerolactone (GVL), 2-methylpyrazine (2MP), N-vinyl-2-pyrrolidinone (NVP; non-polymeric), or a combination of co-solvents.

The concentration of the co-solvent in the surfactant blend may range from about 0.05% w/v to about 12% w/v. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the co-solvent in the surfactant blend fluid may range from about 0.05% (w/v) to about 12% (w/v), from about 0.1% (w/v) to about 12% (w/v), from about 0.5% (w/v) to about 12% (w/v), from about 1% (w/v) to about 12% (w/v), from about 2% (w/v) to about 12% (w/v), from about 3% (w/v) to about 12% (w/v), from about 4% (w/v) to about 12% (w/v), from about 5% (w/v) to about 12% (w/v), from about 6% (w/v) to about 12% (w/v), from about 7% (w/v) to about 12% (w/v), from about 8% (w/v) to about 12% (w/v), from about 9% (w/v) to about 12% (w/v), from about 10% (w/v) to about 12% (w/v), or from about 11% (w/v) to about 12% (w/v). As another example, the concentration of the co-solvent in the surfactant blend fluid may range from about 0.05% (w/v) to about 12% (w/v), from about 0.05% (w/v) to about 11% (w/v), from about 0.05% (w/v) to about 10% (w/v), from about 0.05% (w/v) to about 9% (w/v), from about 0.05% (w/v) to about 8% (w/v), from about 0.05% (w/v) to about 7% (w/v), from about 0.05% (w/v) to about 6% (w/v), from about 0.05% (w/v) to about 5% (w/v), from about 0.05% (w/v) to about 4% (w/v), from about 0.05% (w/v) to about 3% (w/v), from about 0.05% (w/v) to about 2% (w/v), from about 0.05% (w/v) to about 1% (w/v), from about 0.05% (w/v) to about 0.5% (w/v), or from about 0.05% (w/v) to about 0.1% (w/v). With the benefit of this disclosure, one of ordinary skill in the art will be readily able to prepare a hydrocarbon scavenger fluid having a desirable concentration of co-solvent for use in a given wellbore operation.

A water-based nanoparticle dispersion is combined with the microemulsion in any order to produce the hydrocarbon scavenger fluid. In some examples, the water-based nanoparticle dispersion may be combined with one or more components of the microemulsion as the microemulsion is being prepared. The water-based nanoparticle dispersion is a dispersion of nanoparticles in an aqueous base fluid. The nanoparticles generally comprise particles in a size range of between about 20 nm to about 500 nm. The nanoparticle dispersion comprises a mixture of positively charged nanoparticles and negatively charged nanoparticles. In some examples, the nanoparticle dispersion is a non-functionalized nanoparticle dispersion and the nanoparticles do not comprise any additional functionalization or additional groups beyond those that naturally make up their structure. Examples of the nanoparticle may include, but are not limited to, negatively or positively charged particle species comprising the following elements: aluminum, bismuth, cadmium, boron, carbon, calcium, cerium, chromium, cobalt, copper, gallium, gold, indium, iridium, iron, magnesium, manganese, nickel, palladium, platinum, silicon, silver, selenium, thallium, tin, titanium, zinc, or any combination of elements.

Specific examples of the nanoparticle may include, but are not limited to, negatively or positively charged particle species comprising the following molecules: Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, MO₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, and Zr(OH)₄. The nanoparticle may also include colloidal silical sols, an example of which includes, but is not limited to a polysiloxane oligomer. In a preferred example, the nanoparticle dispersion comprises SiO₂ and/or TiO₂.

The completed hydrocarbon scavenger fluid may be used in a variety of wellbore operations including, but not limited to, hydrocarbon recovery operations such as EOR and/or IOR, fracturing operations, stimulation operations, water-flooding operations including low-salinity or “smart” water flooding, injection operations, and the like. In some fracturing operations, proppant may also be added to the hydrocarbon scavenger fluid. In alternative fracturing operations, the hydrocarbon scavenger fluid may be used without proppant. In some water-flooding or injection operations, the hydrocarbon scavenger fluid may be introduced into an injection well and pumped from the wellbore of the injection well into an adjacent subterranean formation where it may then exit into the wellbore of an adjacent producing well.

The hydrocarbon scavenger fluid comprises a pH in a range of about 5 to about 9. In some examples, the pH of the hydrocarbon scavenger fluid is in a range of about 6.5 to about 8.5. A pH adjustor may be added to shift the pH to a desired range. The pH adjustor may be any base sufficient for adjusting the pH of the hydrocarbon scavenger fluid to a range of about 5 to about 9 without negatively impacting the functionality of the other hydrocarbon scavenger fluid components. General examples of the pH adjustor include, but are not limited to, any hydroxide or metal hydroxide, borates, or a combination thereof. Specific examples of the pH adjustor include, but are not limited to, ammonium hydroxide, sodium hydroxides, manganese (II) hydroxide, barium hydroxide octahydrate, aluminum hydroxide, calcium hydroxide, iron (III) hydroxide, barium hydroxide, magnesium hydroxide, potassium hydroxide, chromium (III) hydroxide, tin (IV) hydroxide, chromium (II) hydroxide, silver hydroxide, lead (IV) hydroxide, platinum (IV) hydroxide, zinc hydroxide, copper (II) hydroxide, beryllium hydroxide, vanadium (V) hydroxide, iron (II) hydroxide, manganese (IV) hydroxide, lead (II) hydroxide, strontium hydroxide, tin (II) hydroxide, vanadium (III) hydroxide, lithium hydroxide, mercury (II) hydroxide, nickel (II) hydroxide, mercury (I) hydroxide, copper (I) hydroxide, tetramethylammonium hydroxide, tetraethylammonium hydroxide, tetrabutylammonium hydroxide, choline hydroxide, urea and tetrabutyl urea, isobutylene diurea, amino acids such as alanine, arginine, asparagine, cysteine, glycine, histidine, leucine, lysine, methionine, phenylalanine, proline, serine, taurine, threonine, tryptophan, tyrosine, valine and selenocysteine, aspartic acid, glutamic acid, boric acid, borax, a borate, a (Ci-C₃₀) hydrocarbylboronic acid, a (Ci-C₃₀) hydrocarbyl ester of a (Ci-C₃₀) hydrocarbylboronic acid, a (Ci-C₃₀) hydrocarbylboronic acid-modified polyacrylamide, disodium octaborate tetrahydrate, sodium metaborate, sodium diborate, sodium tetraborate, disodium tetraborate, a pentaborate, ulexite, colemanite, magnesium oxide, phosphorous oxides such as phosphorous pentoxide or trioxide, Group 1 or IA salts of mono-, di-, or tri-, hydrogen phosphate (MₓH_{y}PO₄, x=1,2,3 and y=2,1,0) or phosphite (MₓH_{y}PO₃, x=1,2,3 and y=2,1,0), derivatives thereof, or any combination thereof. A preferred example of the pH adjustor is ammonium hydroxide.

In some optional examples, the hydrocarbon scavenger fluid may comprise an additive. The additive may be used to adjust a property of the hydrocarbon scavenger fluid, for example, the viscosity, density, etc. Examples of the additive may include, but are not limited to, silica scale control additives, corrosion inhibitors, surfactants, gel stabilizers, anti-oxidants, polymer degradation prevention additives, relative stimulations, scale inhibitors, foaming agents, defoaming agents, antifoaming agents, emulsifying agents, de-emulsifying agents, iron control agents, proppants or other particulates, particulate diverters, salts, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, viscosifiers, weighting agents, solubilizers, hydrate inhibitors, consolidating agents, bactericides, clay stabilizers, breakers, delayed release breakers, the like, or any combination thereof. With the benefit of this disclosure, one of ordinary skill in the art will be able to formulate a hydrocarbon scavenger fluid having properties suitable for a desired application.

In some optional examples, the hydrocarbon scavenger fluid does not comprise viscoelastic surfactants. Examples of the excluded viscoelastic surfactants may include, but are not limited to, quad-diamines compounds, erucic dimethyl amidopropyl betaine, cocamidopropyl dimethylamine, cocamidopropyl betaine, or alkylether hydroxypropyl sultaine. In some specific examples, the excluded viscoelastic surfactant has an alkyl chain length of greater than or equal to 16.

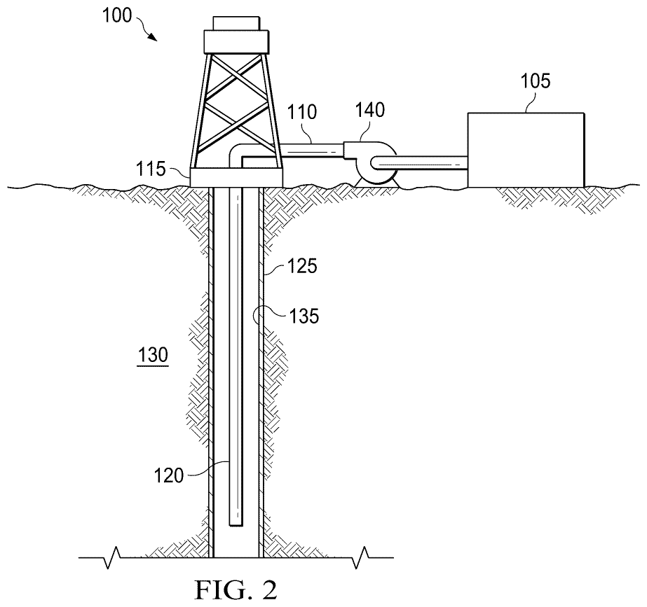

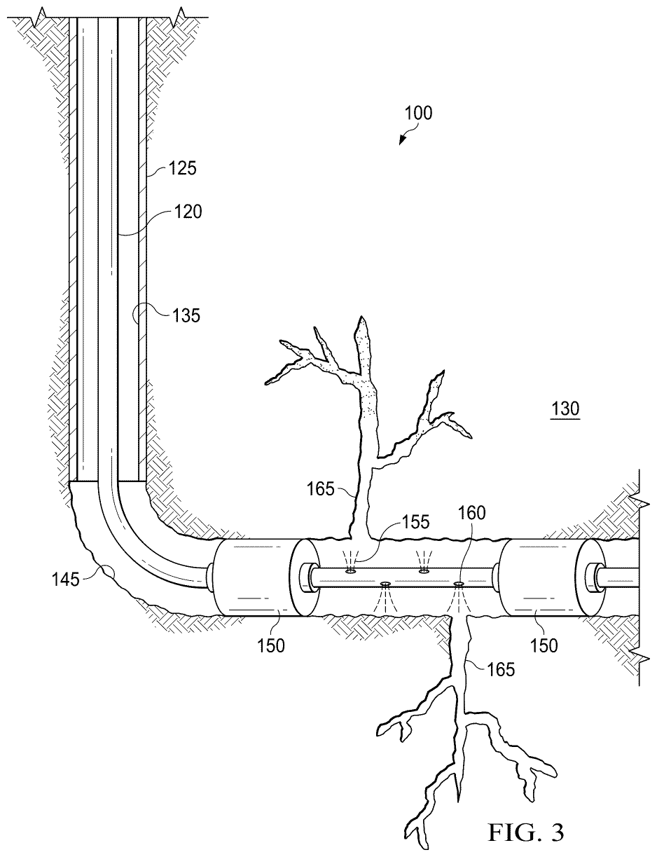

FIG. 2 illustrates a schematic of the surface and near-surface portions of a system 100 that delivers the hydrocarbon scavenger fluid to a downhole location, according to one or more examples described herein. It should be noted that while FIG. 2 generally depicts a land-based system, it is to be recognized that like systems may be operated in subsea locations as well. As depicted in FIG. 2, system 100 includes a mixing tank 105, in which a hydrocarbon scavenger fluid is formulated. The hydrocarbon scavenger fluid may be conveyed to a pump 140 which elevates the hydrocarbon scavenger fluid to a desired pressure to drive the hydrocarbon scavenger fluid to wellhead 115 via line 110, where the hydrocarbon scavenger fluid then enters wellbore conduit 120. Wellbore conduit 120 extends from wellhead 115 into a wellbore 125 penetrating subterranean formation 130. Wellhead 115 is illustrated as comprising a derrick, but it is to be understood that other wellhead 115 arrangements such as a Christmas tree may be used in some examples. Wellbore 125 may be any type of wellbore including vertical, horizontal, deviated, etc. The illustrated portion of wellbore 125 is cased with a casing 135. In some alternative examples, wellbore 125 may be uncased. Upon being ejected from conduit 120, the hydrocarbon scavenger fluid may subsequently enter the subterranean formation 130 as described in FIG. 3 below. Pump 140 is configured to raise the fluid pressure of the hydrocarbon scavenger fluid to a desired pressure before its introduction into conduit 120. The hydrocarbon scavenger fluid may be introduced into the wellbore 125 to improve hydrocarbon mobility and production. The hydrocarbon scavenger fluid may be introduced into the wellbore 125 during or after fracturing of the wellbore 125. The hydrocarbon scavenger fluid may be introduced into the wellbore during or after performing an enhanced oil recovery operation in the wellbore 125. The hydrocarbon scavenger fluid may be introduced into the wellbore 125 during or after performing a completion operation in the wellbore 125, such as cementing a portion of the wellbore. The hydrocarbon scavenger fluid may be introduced into the wellbore 125 during or after performing a water flooding operation in the wellbore 125. The hydrocarbon scavenger fluid may be introduced into the wellbore 125 during or after a different wellbore treatment operation, such as treating the wellbore 125 with a fluid pill (e.g., a fluid loss control pill), an acidizing operation, etc.

FIG. 3 illustrates a schematic of the downhole portion of the system 100 illustrated in FIG. 2, according to one or more examples. In the example of FIG. 3, the hydrocarbon scavenger fluid is introduced into wellbore 125 after a fracturing fluid has been used to form one or more fractures in subterranean formation 130. As depicted in FIG. 3, conduit 120 extends from wellhead 115 (as illustrated in FIG. 2) into wellbore 125 penetrating subterranean formation 130. After descending through heel 145 of wellbore 125, conduit 120 is coupled to one or more packers 150 positioned to isolate an interval of wellbore 125. Hydrocarbon scavenger fluid 155, as described herein, may exit tubular 120 through openings 160. Hydrocarbon scavenger fluid 155 may be introduced into subterranean formation 130 via primary fracture 165 of other such opening into subterranean formation 130. Hydrocarbon scavenger fluid 155 may contact subterranean formation 130 to increase the permeability of subterranean formation 130 and improve overall hydrocarbon mobility. Hydrocarbon scavenger fluid 155 may also contact the fracture faces or rock faces and increase the permeability of the fracture/rock faces.

It is to be recognized that system 100 is merely exemplary in nature, and various additional components may be present that have not necessarily been depicted in FIGS. 2 and 3 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

It should be clearly understood that the examples illustrated by FIGS. 2 and 3 are merely general applications of the principles of this disclosure in practice, and a wide variety of other examples are possible. Therefore, the scope of this disclosure is not limited in any manner to the details of FIGS. 2 and 3 as described herein.

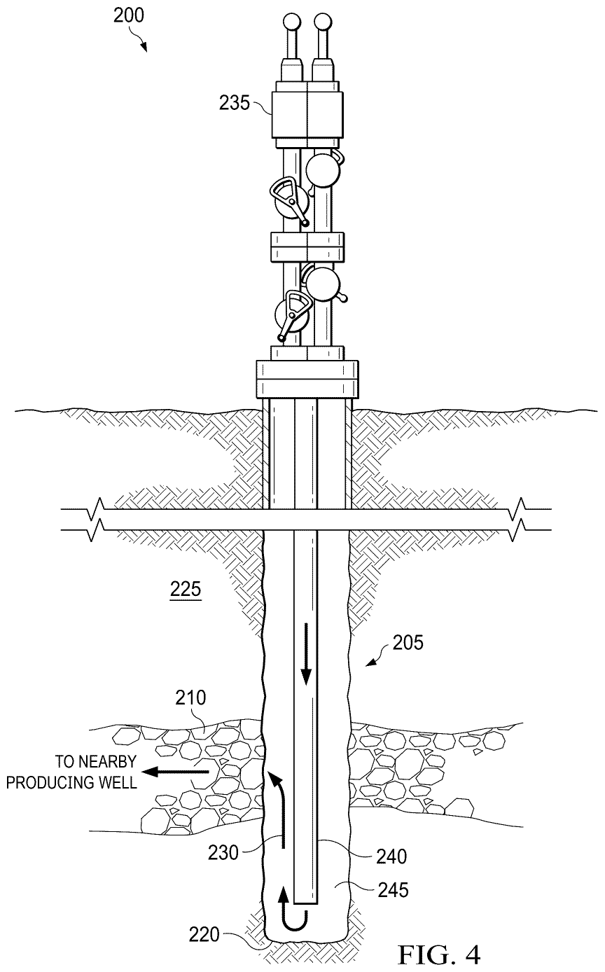

FIG. 4 is a schematic showing one example of a system 200 for injection well 205. Some portions of injection well 205 are illustrated as uncased; however, it is to be understood that the injection well 205 may have portions that are cased or uncased as desired. A hydrocarbon scavenger fluid 230 may be introduced into wellbore 220 via Christmas tree 235, or any other sufficient injection point for wellbore 220. Although system 200 depicts Christmas tree 235 at the wellhead, other wellhead arrangements may be used for the wellbore operation. In the illustrated example, hydrocarbon scavenger fluid 230 is introduced into conduit 240 to the bottom of wellbore 220 and up through annulus 245 where it may contact the target formation interval 210. Hydrocarbon scavenger fluid 230 flows into the adjacent subterranean formation of formation interval 210 to contact any hydrocarbon fluids within. Hydrocarbon scavenger fluid 230 is not flowed back but may enter into subterranean formation 225 at targeted formation interval 210. Hydrocarbon scavenger fluid 230 drives the hydrocarbon fluids into a nearby producing well also penetrating subterranean formation 225. Hydrocarbon scavenger fluid 230 improves the mobility of the hydrocarbon fluids residing within subterranean formation 225.

It should be clearly understood that system 200 illustrated by FIG. 4 is merely a general application of the principles of this disclosure in practice, and a wide variety of other examples are possible. Therefore, the scope of this disclosure is not limited in any manner to the details of FIG. 4 as described herein.

The hydrocarbon scavenger fluid may be of particular benefit in treating subterranean formations having high permeability and low fluid mobility. These subterranean formations may be described as naturally fractured with permeability ranges from ~ 10 to >100 Darcy and hydrocarbon content characterized with API gravity <10, viscosities >5000 cP, asphaltene content >20%, and a pour point >50° C. API gravity refers to American Petroleum Institute gravity and is the measure of how heavy or light a petroleum liquid is compared to water. The formula for calculating API gravity is:

$$API Gravity = \frac{141.5}{S G} - 131.5 ; where SG is the specific gravity of the fluid .$$

The hydrocarbon scavenger fluids disclosed herein may directly or indirectly affect one or more components or pieces of equipment associated with or which may come into contact with the hydrocarbon scavenger fluid s such as, but not limited to, wellbore casing, wellbore liner, completion string, insert strings, drill string, coiled tubing, slickline, wireline, drill pipe, drill collars, mud motors, downhole motors and/or pumps such as electrosubmersible pumps (ESPs), cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), jetting tools, sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

To facilitate a better understanding of the present embodiments, the following examples of certain aspects of some embodiments are given. In no way should the following examples be read to limit, or define, the entire scope of the embodiments.

### Examples

An experiment was conducted to compare the performance of various formulations of hydrocarbon scavenger fluids. Table 1 provides the performance characteristics of experimental hydrocarbon scavenger fluids. Table 2 provides the formulations of the hydrocarbon scavenger fluids seen in Table 1. Entries 1-4 are control samples comprising either a nanoparticle dispersion of SiO₂ or TiO₂ or a low or high polarity microemulsion (LPME and HPME respectively).

TABLE 1
Comparison of Hydocarbon Scavenger Fluid Performance.

| | | Zeta | Droplet | | |
|---|---|---|---|---|---|
| | | Potential | Size Rh | IFT | Δ Contact |
| Entry | Sample | (mV) | (avg) | (mN/m) | Angle % |
| 1 | SiO2 | −42.56 | 130.3 | 1.02 | 63 |
| 2 | TiO2 | −46.39 | 145.1 | 0.08 | 88 |
| 3 | HPME | −23.42 | 121.7 | 0.53 | NA |
| 4 | LPME | −19.82 | 20 | 0.802 | NA |
| 5 | SiO2 + | −24.37 | 284.3 | 0.29 | 103 |
| | HPME | | | | |
| 6 | SiO2 + | −15.89 | 62.9 | 1.25 | 182 |
| | LPME | | | | |
| 7 | TiO2 + | −17.09 | 126.3 | 3.3 | 45 |
| | HPME | | | | |
| 8 | TiO2 + | −22.30 | 179.8 | 0.66 | 124 |
| | LPME | | | | |

As shown in Table 1, the combination of the SiO₂ with the low polarity microemulsion resulted in an unexpected change in the contact angle of 182%. The high polarity microemulsions were still useful, but did not produce as large a degree of change in the contact angle as the low polarity microemulsions. Moreover, SiO₂ induced a larger change in the contact angle than TiO₂. The formulations of these tested samples are provided below in Table 2.

TABLE 2
Sample Formulations.

| | | | | | | SiO₂ + | SiO₂ + | TiO₂ + | TiO₂ + |
|---|---|---|---|---|---|---|---|---|---|
| | | SiO₂ | TiO₂ | HPME | LPME | HPME | LPME | HPME | LPME |
| Component | Category | Wt. % | Wt. % | Wt. % | Wt. % | Wt. % | Wt. % | Wt. % | Wt. % |
| Water | Water | 99 | 99 | 15 | 20 | 0.6 | 0.8 | 0.6 | 0.8 |
| SiO₂ | Nanoparticle | 1 | | | | 96 | 96 | | |
| TiO₂ | Nanoparticle | | 1 | | | | | 96 | 96 |
| Methyl 9- | High | | | 27 | 20 | 1.08 | | 1.08 | |
| Decenoate | Solvency | | | | | | | | |
| | Substance | | | | | | | | |
| Dearomatized | Low | | | | | | 0.8 | | 0.8 |
| Petroleum | Solvency | | | | | | | | |
| Distillates | Substance | | | | | | | | |
| Alkoxylated | Surfactant | | | 5 | 10 | 0.2 | 0.4 | 0.2 | 0.4 |
| Alcohol | | | | | | | | | |
| Alkanolamide | Surfactant | | | 5 | 10 | 0.2 | 0.4 | 0.2 | 0.4 |
| Alkoxylated | Surfactant | | | 5 | 10 | 0.2 | 0.4 | 0.2 | 0.4 |
| Fatty Acid | | | | | | | | | |
| Ethoxylated | Surfactant | | | 10 | | 0.4 | | 0.4 | |
| Alkylphenol | | | | | | | | | |
| Resin | | | | | | | | | |
| Alkoxylate | Surfactant | | | 10 | | 0.4 | | 0.4 | |
| Alkylphenol | | | | | | | | | |
| Resin | | | | | | | | | |
| Isotridecyl | Co-Solvent | | | 10 | | 0.4 | | 0.4 | |
| Alcohol | | | | | | | | | |
| 1-Butanol | Co-Solvent | | | 3 | 10 | 0.12 | 0.4 | 0.12 | 0.4 |
| Methanol | Co-Solvent | | | 10 | 20 | 0.4 | 0.8 | 0.4 | 0.8 |
| Total | | 100 | 100 | 100 | 100 | 100 | 100 | 100 | 100 |

Provided are hydrocarbon scavenger fluids for treating a wellbore in accordance with the disclosure and the illustrated FIGs. An example hydrocarbon scavenger fluid comprises a microemulsion and a water-based nanoparticle dispersion.

Additionally or alternatively, the hydrocarbon scavenger fluids may include one or more of the following features individually or in combination. The microemulsion may comprise a surfactant blend comprising two surfactants selected from the group consisting of alkanolamides, alkylamine alkoxylates, polyether polyamines, alkoxylated polyethylene amine, alkoxylated alcohols, alkoxylated fatty acids, alkyl glycosides, alkylamine-oxides, Alkoxylated alkylphenol resin, EO/PO block copolymers, polyether polyols, triethanolamine linear alkoxylate sulfonate, bis-oxo-diphenol-di-sulfonate, and any combination thereof. The surfactant blend may comprise a co-solvent selected from the group consisting of methanol, ethanol, n-propanol, isopropanol, 1-butanol, 2-butanol, isobutanol, tert-butanol, isotridecyl alcohol, ethylene glycol monobutyl ether, polyethylene glycol monobutyl ether, dimethylisosorbide, cyrene, and any combination thereof. The water-based nanoparticle dispersion may comprise a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, MO₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof. The microemulsion may comprise a non-water-miscible substance selected from the group consisting of 2-butoxyethanol, 1-dodecyl-2-pyrrolidinone, methyl 9 decenoate, dimethyl 2-methylgluturate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, and any combination thereof. The non-water-miscible substance may have a Kauri-butanol (KB) value of about 0 to about 40. The nanoparticle dispersion may comprise a mixture of positively charged nanoparticles and negatively charged nanoparticles. The nanoparticle dispersion may comprise silicon dioxide (SiO₂), titanium dioxide (TiO₂), iron oxide (Fe₃O₄), zinc oxide (ZnO), or a combination thereof. The hydrocarbon scavenger fluid may further comprise a polysaccharide gel, a borate crosslinked polysaccharide gel, a metal crosslinked polysaccharide gel, an acrylamide-based polymer, a metal crosslinked acrylamide-based polymer, an organically crosslinked acrylamide-based polymer, a clay control additive, a shale stabilization additive, a fluid loss additive, or a combination thereof.

Provided are methods for treating a wellbore with a hydrocarbon scavenger fluid in accordance with the disclosure and the illustrated FIGs. An example method comprises introducing a hydrocarbon scavenger fluid into a wellbore penetrating the subterranean formation and contacting a rock surface in the subterranean formation with the hydrocarbon scavenger fluid. The hydrocarbon scavenger fluid comprises a microemulsion and a water-based nanoparticle dispersion.

Additionally or alternatively, the method may include one or more of the following features individually or in combination. The wellbore may be a first wellbore that is a wellbore of an injection well and the method may further comprise pumping the hydrocarbon scavenger fluid through the first wellbore, into the subterranean formation, and then into a second wellbore that is a wellbore of a producing well. The introducing the hydrocarbon scavenger fluid into the wellbore may comprise introducing the hydrocarbon scavenger fluid at a pressure sufficient to create or expand a fracture in the subterranean formation. The subterranean formation may have a permeability ranging from darcy to picodarcy and a hydrocarbon fluid in the subterranean formation has an API gravity of between about 0 to about 10 and a viscosity between about 0 cP to about 5,000 cP. The microemulsion may comprise a surfactant blend comprising two surfactants selected from the group consisting of alkanolamides, alkylamine alkoxylates, polyether polyamines, alkoxylated polyethylene amine, alkoxylated alcohols, alkoxylated fatty acids, alkyl glycosides, alkylamine-oxides, Alkoxylated alkylphenol resin, EO/PO block copolymers, polyether polyols, triethanolamine linear alkoxylate sulfonate, bis-oxo-diphenol-di-sulfonate, and any combination thereof. The surfactant blend may comprise a co-solvent selected from the group consisting of methanol, ethanol, n-propanol, isopropanol, 1-butanol, 2-butanol, isobutanol, tert-butanol, isotridecyl alcohol, ethylene glycol monobutyl ether, polyethylene glycol monobutyl ether, dimethylisosorbide, cyrene, and any combination thereof. The water-based nanoparticle dispersion may comprise a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, MO₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof. The microemulsion may comprise a non-water-miscible substance selected from the group consisting of 2-butoxyethanol, 1-dodecyl-2-pyrrolidinone, methyl 9 decenoate, dimethyl 2-methylgluturate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, and any combination thereof. The non-water-miscible substance may have a Kauri-butanol (KB) value of about 0 to about 40. The nanoparticle dispersion may comprise a mixture of positively charged nanoparticles and negatively charged nanoparticles. The nanoparticle dispersion may comprise silicon dioxide (SiO₂), titanium dioxide (TiO₂), iron oxide (Fe₃O₄), zinc oxide (ZnO), or a combination thereof. The hydrocarbon scavenger fluid may further comprise a polysaccharide gel, a borate crosslinked polysaccharide gel, a metal crosslinked polysaccharide gel, an acrylamide-based polymer, a metal crosslinked acrylamide-based polymer, an organically crosslinked acrylamide-based polymer, a clay control additive, a shale stabilization additive, a fluid loss additive, or a combination thereof.

Provided are systems for treating a wellbore with a hydrocarbon scavenger fluid in accordance with the disclosure and the illustrated FIGs. An example system comprises a hydrocarbon scavenger fluid comprising a microemulsion and a water-based nanoparticle dispersion, mixing equipment configured to mix the microemulsion and the water-based nanoparticle dispersion, and pumping equipment configured to pump the hydrocarbon scavenger fluid in the wellbore.

Additionally or alternatively, the system may include one or more of the following features individually or in combination. The pumping equipment may be configured to pump the hydrocarbon scavenger fluid at a pressure sufficient to create or expand a fracture in the subterranean formation. The microemulsion may comprise a surfactant blend comprising two surfactants selected from the group consisting of alkanolamides, alkylamine alkoxylates, polyether polyamines, alkoxylated polyethylene amine, alkoxylated alcohols, alkoxylated fatty acids, alkyl glycosides, alkylamine-oxides, Alkoxylated alkylphenol resin, EO/PO block copolymers, polyether polyols, triethanolamine linear alkoxylate sulfonate, bis-oxo-diphenol-di-sulfonate, and any combination thereof. The surfactant blend may comprise a co-solvent selected from the group consisting of methanol, ethanol, n-propanol, isopropanol, 1-butanol, 2-butanol, isobutanol, tert-butanol, isotridecyl alcohol, ethylene glycol monobutyl ether, polyethylene glycol monobutyl ether, dimethylisosorbide, cyrene, and any combination thereof. The water-based nanoparticle dispersion may comprise a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, Mo₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof. The microemulsion may comprise a non-water-miscible substance selected from the group consisting of 2-butoxyethanol, 1-dodecyl-2-pyrrolidinone, methyl 9 decenoate, dimethyl 2-methylgluturate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, and any combination thereof. The non-water-miscible substance may have a Kauri-butanol (KB) value of about 0 to about 40. The nanoparticle dispersion may comprise a mixture of positively charged nanoparticles and negatively charged nanoparticles. The nanoparticle dispersion may comprise silicon dioxide (SiO₂), titanium dioxide (TiO₂), iron oxide (Fe₃O₄), zinc oxide (ZnO), or a combination thereof. The hydrocarbon scavenger fluid may further comprise a polysaccharide gel, a borate crosslinked polysaccharide gel, a metal crosslinked polysaccharide gel, an acrylamide-based polymer, a metal crosslinked acrylamide-based polymer, an organically crosslinked acrylamide-based polymer, a clay control additive, a shale stabilization additive, a fluid loss additive, or a combination thereof.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

1. A hydrocarbon scavenger fluid for a wellbore, the hydrocarbon scavenger fluid comprises:
a microemulsion, and
a water-based nanoparticle dispersion.

2. The hydrocarbon scavenger fluid of claim 1, wherein the microemulsion comprises a surfactant blend comprising two surfactants selected from the group consisting of alkanolamides, alkylamine alkoxylates, polyether polyamines, alkoxylated polyethylene amine, alkoxylated alcohols, alkoxylated fatty acids, alkyl glycosides, alkylamine-oxides, Alkoxylated alkylphenol resin, EO/PO block copolymers, polyether polyols, triethanolamine linear alkoxylate sulfonate, bis-oxo-diphenol-di-sulfonate, and any combination thereof.

3. The hydrocarbon scavenger fluid of claim 2, wherein the surfactant blend comprises a co-solvent selected from the group consisting of methanol, ethanol, n-propanol, isopropanol,1-butanol, 2-butanol, isobutanol, tert-butanol, isotridecyl alcohol, ethylene glycol monobutyl ether, polyethylene glycol monobutyl ether, dimethylisosorbide, cyrene, and any combination thereof.

4. The hydrocarbon scavenger fluid of claim 1, wherein the water-based nanoparticle dispersion comprises a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, C₀₃₀₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, Mo₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof.

5. The hydrocarbon scavenger fluid of claim 1, wherein the microemulsion comprises a non-water-miscible substance selected from the group consisting of 2-butoxyethanol, 1-dodecyl-2-pyrrolidinone, methyl 9 decenoate, dimethyl 2-methylgluturate, terpenes, oil of terpentine, hexane, hydrotreated petroleum distillates, dearomatized petroleum distillates, n-hexane, n-dodecane, n-tetradecane, light mineral oil, heavy mineral oil, pure mineral oil, and any combination thereof.

6. The hydrocarbon scavenger fluid of claim 5, wherein the non-water-miscible substance has a Kauri-butanol (KB) value of about 0 to about 40.

7. The hydrocarbon scavenger fluid of claim 1, wherein the nanoparticle dispersion comprises a mixture of positively charged nanoparticles and negatively charged nanoparticles.

8. The hydrocarbon scavenger fluid of claim 1, wherein the nanoparticle dispersion comprises silicon dioxide (SiO₂), titanium dioxide (TiO₂), iron oxide (Fe₃O₄), zinc oxide (ZnO), or a combination thereof.

9. The hydrocarbon scavenger fluid of claim 1, further comprising a polysaccharide gel, a borate crosslinked polysaccharide gel, a metal crosslinked polysaccharide gel, an acrylamide-based polymer, a metal crosslinked acrylamide-based polymer, an organically crosslinked acrylamide-based polymer, a clay control additive, a shale stabilization additive, a fluid loss additive, or a combination thereof.

10. A method for treating a subterranean formation, the method comprises:
introducing a hydrocarbon scavenger fluid into a wellbore penetrating the subterranean formation, the hydrocarbon scavenger fluid comprising:
a microemulsion, and
a water-based nanoparticle dispersion; and
contacting a rock surface in the subterranean formation with the hydrocarbon scavenger fluid.

11. The method of claim 10, wherein the wellbore is a first wellbore and is a wellbore of an injection well; wherein the method further comprises pumping the hydrocarbon scavenger fluid through the first wellbore, into the subterranean formation, and then into a second wellbore that is a wellbore of a producing well.

12. The method of claim 10, wherein the introducing the hydrocarbon scavenger fluid into the wellbore comprises introducing the hydrocarbon scavenger fluid at a pressure sufficient to create or expand a fracture in the subterranean formation.

13. The method of claim 10, wherein the subterranean formation has a permeability ranging from darcy to picodarcy and a hydrocarbon fluid in the subterranean formation has an API gravity of between 0 to 10 and a viscosity between 0 cP to 5,000 cP.

14. The method of claim 10, wherein the microemulsion comprises a non-water-miscible substance having a Kauri-butanol (KB) value of 0 to 40; wherein the Kauri-butanol (KB) value is determined by the Kauri-butanol (KB) standard of Jan. 9, 2025.

15. The method of claim 10, wherein the water-based nanoparticle dispersion comprises a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, Mo₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof.

16. A system for treating a subterranean formation, the system comprises:
a hydrocarbon scavenger fluid comprising:
a microemulsion, and
a water-based nanoparticle dispersion;
mixing equipment configured to mix the microemulsion and the water-based nanoparticle dispersion; and
pumping equipment configured to pump the hydrocarbon scavenger fluid in the wellbore to contact a rock surface of the subterranean formation.

17. The system of claim 16, wherein the pumping equipment is configured to pump the hydrocarbon scavenger fluid at a pressure sufficient to create or expand a fracture in the subterranean formation.

18. The system of claim 16, wherein the microemulsion comprises a non-water-miscible substance having a Kauri-butanol (KB) value of 0 to 40; wherein the Kauri-butanol (KB) value is determined by the Kauri-butanol (KB) standard of Jan. 9, 2025.

19. The system of claim 16, wherein the water-based nanoparticle dispersion comprises a nanoparticle selected from the group consisting of Al₂O₃, Al(OH)₃, Al(BaCO)₃, Al(CH₃OO)₃, BaTiO₃, BaSO₄, Bi₂O₃, CaCO₃, CaSO₄, CdS, CeO₂, CoFe₂O₄, Co(II)O, Co₂O₃, Co₃O₄, Cr₃C₂, CrN₃, Cr₂O₃, CuO, Cu₂O, Cu(OH)₂, Cu(CH₃COO)₂, CuS, Fe₂O₃, Fe₃O₄, MgCO₃, Mo₂C, MoS₂, MoSi₂, MnFe₂O₄, MnO₂, MoSi₂, MnFe₂O₄, MnO₂, Mn₃O₄, NbC, Ni(OH)₂, NiO, SiC, Si₃N₄, SiO₂, SnO₂, SrCO₃, SrTiO₃, TiC, TiO₂, ZnO, ZnCO₃, ZrO₂, Zr(OH)₄, and any combination thereof.

20. The system of claim 16, wherein the nanoparticle dispersion comprises silicon dioxide (SiO₂), titanium dioxide (TiO₂), iron oxide (Fe₃O₄), or a combination thereof.
